(19) United States
(12) Patent Application Publication
(10) Pub. No.: US 2023/0252155 A1
(43) Pub. Date: Aug. 10, 2023

(54) ELECTRONIC DEVICE MONITORING APPARATUS, MOVING BODY, AND ELECTRONIC DEVICE MONITORING METHOD

(71) Applicant: HONDA MOTOR CO., LTD., Tokyo (JP)

(72) Inventors: Hisahiro Kato, Tokyo (JP); Hiroaki Hakukawa, Tokyo (JP); Tomoya Nishino, Tokyo (JP); Noboru Ujigawa, Tokyo (JP)

(21) Appl. No.: 18/155,158

(22) Filed: Jan. 17, 2023

(30) Foreign Application Priority Data
Feb. 8, 2022 (JP) 2022-017666

(51) Int. Cl. G06F 21/57

(52) U.S. Cl. CPC G06F 21/575; G06F 21/572; G06F 2221/034

(57) ABSTRACT

An electronic device monitoring apparatus includes: a control unit that periodically shifts from a sleep state to an active state and executes predetermined standby processing while an electronic device is not in use; a storage unit that stores specific data to be subjected to alteration verification processing for verifying whether there is any alteration. The control unit executes sub data verification processing, the sub data verification processing performing the alteration verification processing for at least one piece of sub data out of a plurality of pieces of sub data at every shift to the active state in a preset order, the plurality of pieces of sub data being obtained by subdividing the specific data.

### INCORPORATION BY REFERENCE

The present application claims priority under 35 U.S.C. § 119 to Japanese Patent Application No. 2022-017666 filed on Feb. 8, 2022. The content of the application is incorporated herein by reference in its entirety.

### BACKGROUND OF THE INVENTION

### Field of the Invention

The present invention relates to an electronic device monitoring apparatus, a moving body, and an electronic device monitoring method.

### Description of the Related Art

Secure boot technologies are traditionally known that verify whether data such as firmware have been altered in activation of an electronic device and let the device activate if it is authenticated that the data has not been altered (see, for example, Japanese Patent Laid-Open No. 2021-2168). Japanese Patent Laid-Open No. 2021-2168 discloses a technique for shortening an activation time by collectively authenticating a plurality of firmware units verified not to be altered.

In moving bodies, each of which is an example of the electronic device, it is desired to verify that the data has not been altered at a start-up of the moving body to improve traffic safety. Unfortunately, processing to verify whether there is any alteration lengthens the time required for the activation of the electronic device, leading to poor usability for the user. Also, it is desirable to verify that the data has not been altered while improving energy efficiency.

The present invention has been made in view of this background, and it is an object of the present invention to provide an electronic device monitoring apparatus, a moving body, and an electronic device monitoring method, for verifying that data has not been altered while improving energy efficiency, and for reducing activation time at a start-up of an electronic device.

### SUMMARY OF THE INVENTION

A first aspect for achieving the above object is an electronic device monitoring apparatus including: a control unit that periodically shifts from a sleep state to an active state and executes predetermined standby processing while an electronic device is not in use; and a storage unit that stores specific data to be subjected to alteration verification processing for verifying whether there is any alteration, wherein the control unit executes sub data verification processing, the sub data verification processing performing the alteration verification processing for at least one piece of sub data out of a plurality of pieces of sub data at every shift to the active state in a preset order, the plurality of pieces of sub data being obtained by subdividing the specific data.

The above electronic device monitoring apparatus may be configured such that the control unit stores information of no-alteration-confirmed in the storage unit, the information of no-alteration-confirmed indicating that the specific data has not been altered when the sub data verification processing verifies that none of all the sub data has been altered.

The above electronic device monitoring apparatus may be configured such that, when a start-up condition of the electronic device is met in a state in which the information of no-alteration-confirmed is stored in the storage unit, the control unit does not re-execute the alteration verification processing for the specific data and executes activation processing of the electronic device.

The above electronic device monitoring apparatus may be configured such that, when a predetermined time elapses from a time when the sub data verification processing completes the alteration verification processing for all the sub data, the control unit re-executes the sub data verification processing.

The above electronic device monitoring apparatus may be configured such that, when a start-up condition of the electronic device is met before the sub data verification processing completes the alteration verification processing for all the sub data, the control unit executes the alteration verification processing only for the sub data for which the alteration verification processing has not been completed and then executes activation processing of the electronic device.

The above electronic device monitoring apparatus may be configured such that, when a start-up condition of the electronic device is met before the sub data verification processing completes the alteration verification processing for all the sub data, the control unit executes the alteration verification processing for the sub data for which the alteration verification processing has not been completed, and subsequently, at execution of the activation processing of the electronic device, the control unit re-executes the alteration verification processing also for the sub data for which the alteration verification processing has already been completed.

The above electronic device monitoring apparatus may be configured such that the specific data is data of an application to be executed at a start-up of the electronic device, the application includes a first application and a second application, the first application is configured to be executable in parallel with the alteration verification processing for data of the first application, and the second application is configured to be executable after completion of the alteration verification processing for data of the second application, and the control unit concurrently performs the alteration verification processing for data of the first application and execution of the first application when the sub data for which the alteration verification processing has not been completed is data of the first application, and the control unit executes the second application after completion of the alteration verification processing for data of the second application when the sub data for which the alteration verification processing has not been completed is data of the second application.

The above electronic device monitoring apparatus may be configured such that the control unit executes predetermined fail-safe processing when the sub data verification processing recognizes that the sub data has been altered.

A second aspect for achieving the above object is a moving body being an electronic device, the moving body including an electronic device monitoring apparatus.

A third aspect for achieving the above object is an electronic device monitoring method to be executed by a computer, the method including: a step of periodically shifting from a sleep state to an active state and executing predetermined standby processing while an electronic device is not in use; and a step of executing sub data verification processing, the sub data verification processing performing alteration verification processing for at least one piece of sub data out of a plurality of pieces of sub data at every shift to the active state in a preset order, the alteration verification processing verifying whether the sub data has been altered, the plurality of pieces of sub data being obtained by subdividing specific data, stored in a storage unit, to be subjected to the alteration verification processing.

The electronic device monitoring apparatus, the moving body, and the electronic device monitoring method described above makes it possible to verify that data has not been altered while improving energy efficiency and to reduce the activation time at the start-up of the electronic device.

### BRIEF DESCRIPTION OF THE DRAWINGS

FIG. 1 is a configuration diagram of an electronic device monitoring apparatus;

FIG. 2 is a flowchart of monitoring processing and alteration verification processing;

FIG. 3 is an explanatory diagram of the alteration verification processing while a vehicle is not in use; and

FIG. 4 is an explanatory diagram in a case in which the vehicle is started up before alteration verification processing for all sub data is completed.

### DETAILED DESCRIPTION OF THE PREFERRED EMBODIMENTS

### 1. Configuration of Electronic Device Monitoring Apparatus

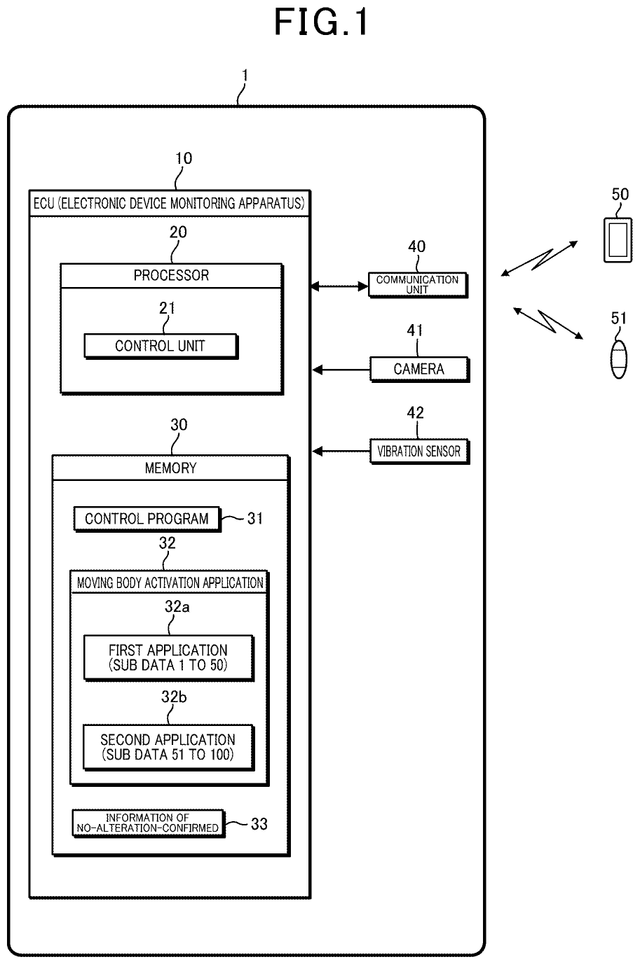

With reference to FIG. 1, the configuration of the electronic device monitoring apparatus of the present embodiment will be described. The electronic device monitoring apparatus of the present embodiment is provided in a vehicle 1 and configured as a function of an electronic control unit (ECU) 10 that controls the operation of the vehicle 1. The ECU 10 includes a processor 20 and a memory 30. The vehicle 1 corresponds to the moving body and electronic device of the present disclosure.

The vehicle 1 includes a communication unit 40, a camera 41 for photographing the surroundings of the vehicle 1, and a vibration sensor 42 for detecting vibrations of the vehicle 1. The ECU 10 communicates with a portable terminal 50 and a portable key 51 used by the user of the vehicle 1 via the communication unit 40. An image captured by the camera 41 and a vibration detection signal detected by the vibration sensor 42 are also input to the ECU 10. The portable terminal 50 is a communication terminal such as a smart phone, a mobile phone, a tablet terminal, etc., and has a virtual key application (application program) installed therein that functions as a virtual key for the vehicle 1.

The memory 30 stores a control program 31 for the vehicle 1 and a moving body activation application 32 to be executed at the start-up of the vehicle 1. The memory 30 also stores information of no-alteration-confirmed 33 that indicates that it is verified that no data related to the moving body activation application 32 has been altered. The data of the moving body activation application 32 corresponds to data of an application to be executed at the start-up of the electronic device of the present disclosure and specific data.

The moving body activation application 32 includes a first application 32a and a second application 32b. The first application 32a corresponds to a first application of the present disclosure, and the second application 32b corresponds to a second application of the present disclosure. The first application 32a is configured to be executable in parallel with verification that no data of the first application 32a are altered. The second application 32b is configured to be executable after completion of verification that no data of the second application 32b are altered. The data of the first application 32a is subdivided into sub data 1 to 50, and the data of the second application 32b is subdivided into sub data 51 to 100.

The processor 20 reads and executes the control program 31 to function as a control unit 21. The processing executed by the control unit 21 includes a step of executing predetermined standby processing according to an electronic device monitoring method of the present disclosure, and a step of executing sub data verification processing. The control unit 21 periodically shifts the ECU 10 from a sleep state to an active state to execute monitoring processing for the vehicle 1 while the vehicle 1 is not in use.

In the sleep state, the processing performance of the processor 20 is lower than in the active state, and power consumption is lower than in the active state. When the ECU 10 is in the sleep state, the control unit 21 executes only limited processing such as acceptance of operation for start-up of the vehicle 1 through communication with the portable terminal 50 and the portable key 51.

The control unit 21 executes the monitoring processing for the vehicle 1, such as sounding the horn (not shown) provided in the vehicle 1 and notifying the portable terminal 50 of the user, if vibration of the vehicle 1 is detected by the vibration sensor 42 due to mischief or the like on the vehicle 1. The monitoring processing corresponds to the standby processing of the present disclosure. The process such as sounding the horn provided in the vehicle 1 and notifying the portable terminal 50 of the user may be executed if a suspicious person or the like approaching the vehicle 1 is recognized from the image, captured by the camera 41, of the surroundings of the vehicle 1. The standby processing includes transmission of maintenance information of the vehicle 1 to the portable terminal 50 or a vehicle management server (not shown) in addition to the monitoring processing. In addition, the control unit 21 executes alteration verification to verify whether the data of the moving body activation application 32 has been altered.

### 2. Processing While the Vehicle 1 is not in Use

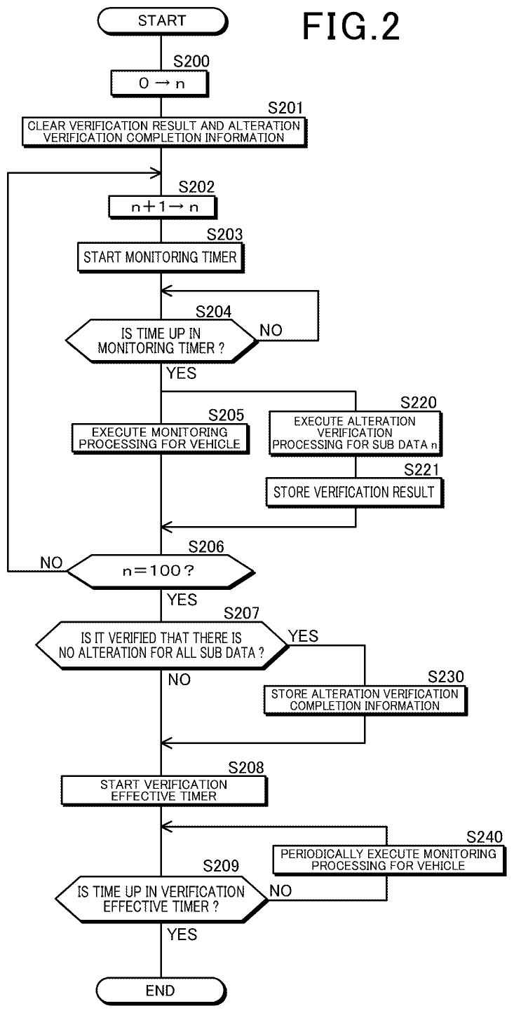

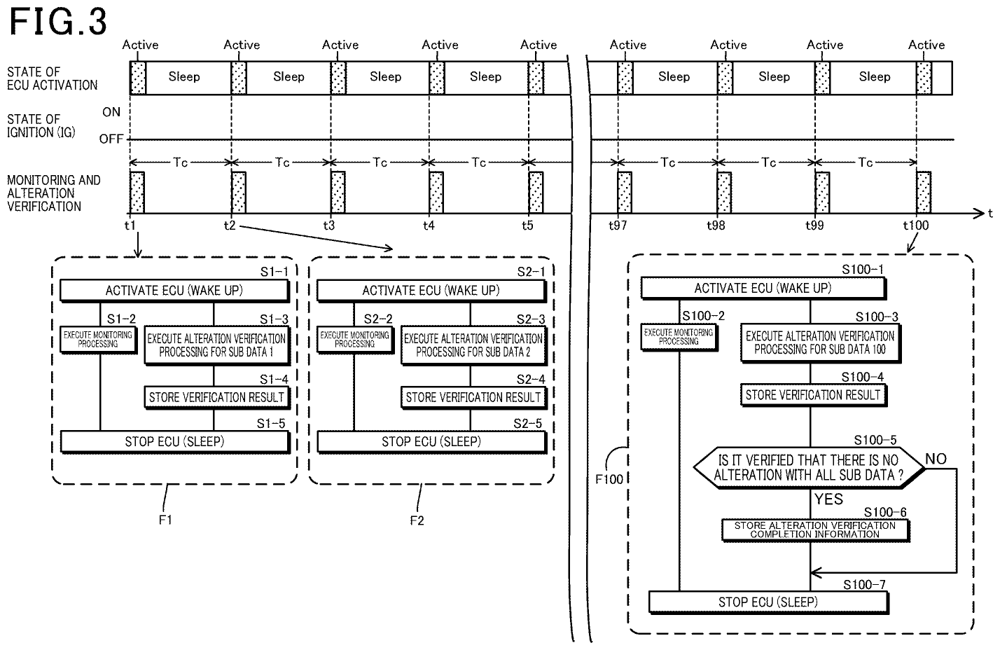

With reference to FIGS. 2 and 3, the following describes the monitoring processing for the vehicle 1 and the alteration verification processing for the data of the moving body activation application 32 that are executed by the control unit 21 while the vehicle 1 is not in use.

The control unit 21 repeatedly executes the processing according to the flowchart shown in FIG. 2 while the vehicle 1 is not in use. The control unit 21 resets the variable n (0→n) in step S200, and clears the verification result and information of no-alteration-confirmed on each sub data in subsequent step S210. Through the loop processing of the following steps S202 to S206 and steps S220 and S221, the control unit 21 executes sub data verification processing for the sub data 1 to 100 of the first application 32a and the second application 32b. The sub data verification processing sequentially performs the alteration verification processing from the sub data 1 to the sub data 100.

The control unit 21 increments the variable n (n+1→n) in step S202, and starts a monitoring timer in step S204. When time is up in the monitoring timer in the next step S204, the control unit 21 executes the monitoring processing described above in step S205. In parallel with step S204, alteration verification processing is executed for sub data n in step S220. In the following step S221, the control unit 21 stores a verification result of whether the sub data is altered, which is determined through the alteration verification process, in the memory 30.

Then, the control unit 21 advances the process to step S207 when the alteration verification processing is completed for all of the sub data 1 to 100 and n becomes 100 in step S206. In step S207, the control unit 21 determines whether it is verified that none of the sub data 1 to 100 have been altered. Then, when it is verified that none of all the sub data 1 to 100 have been altered, the control unit 21 advances the process to step S230 and stores the information of no-alteration-confirmed 33 in the memory 30.

In contrast, when it is verified that at least one of the sub data 1 to 100 has been altered, the control unit 21 advances the process to step S208, and does not store the information of no-alteration-confirmed 33 in the memory 30. After that, for example, at the time when the power of the vehicle 1 is turned on, the control unit 21 executes the following first to third processes as the fail-safe processing.

A first process: notification of an abnormal state. For example, the notification of the abnormal state is performed as follows. The user is notified of the abnormal state through indication of the abnormality due to alteration on the meter, display, etc. of the vehicle 1. The information on abnormality due to alteration is also transmitted to the portable terminal 50, the vehicle management server, the insurance company server, the security company server, and the like via the communication unit 40. In addition, the user is notified of the abnormality through buzzer sound output from the speaker of the vehicle 1.

A second process: prohibition of traveling. The prohibition of traveling is performed in such a way that authentication by the immobilizer is prohibited and the power plant system of the vehicle 1 is not permitted to be driven.

A third process: over-the-air (OTA) software updating. The OTA software updating is performed through a notification prompting the user to update the application program to a legitimate one.

At the next step S208, the control unit 21 starts a verification effective timer. The set time of the verification effective timer corresponds to a predetermined time of the present disclosure. Until the time is up in the verification effective timer in the subsequent step S209, the control unit 21 advances the process to step S240 and periodically executes the monitoring processing of vehicle 1 in the same manner as in step S205. If the time is up in the verification effective timer in step S209, the control unit 21 again executes the sub data verification processing according to the flowchart of FIG. 2.

FIG. 3 is an explanatory diagram with a timing diagram illustrating the processing according to the flowchart of FIG. 2 described above. FIG. 3 illustrates activation of the ECU 10 (shift from a sleep state to an active state), power on/off state of the vehicle 1, and execution timing of monitoring processing and alteration verification processing, on a common time axis t.

In FIG. 3, the control unit ECU 10 shifts from the sleep state to the active state at a period Tc that is a time set with the monitoring timer or at times sequentially from t1 to t100, and concurrently executes the monitoring processing of vehicle 1 and the alteration verification processing of sub data 1 to 100. For example, at the time t1, the control unit 21 executes the process of F1. In the process of F1, the control unit 21 activates the ECU 10 in step S1-1 (shifts from the sleep state to the active state), executes the monitoring processing in step S1-2, and executes alteration verification processing for sub data 1 in step S1-3 and stores the verification result in the memory 30 in step S1-4.

Similarly, the control unit 21 sequentially executes the processes from F2 to F100 that are respectively the alteration verification processing for the sub data 2 to 100 at the times t2 to t100. In F100, if the control unit 21 verifies that no sub data has been altered in step S100-5, the control unit 21 stores the information of no-alteration-confirmed 33 in the memory 30 in step S100-6.

### 3. Processing at Start-up of Vehicle

When the user operates the vehicle 1 to start up in a state in which it is verified that none of all the sub data 1 to 100 have been altered and the information of no-alteration-confirmed 33 is stored in the memory 30, the control unit 21 executes the moving body activation application 32 without performing the alteration verification processing for the data of the moving body activation application 32. The operation of the user for start-up of the vehicle 1 corresponds to a start-up condition of an electronic device of the present disclosure. Note that, for example, if the vehicle is an automatically driven vehicle that travels according to a preset operation schedule, the start-up condition is that the operation start time comes.

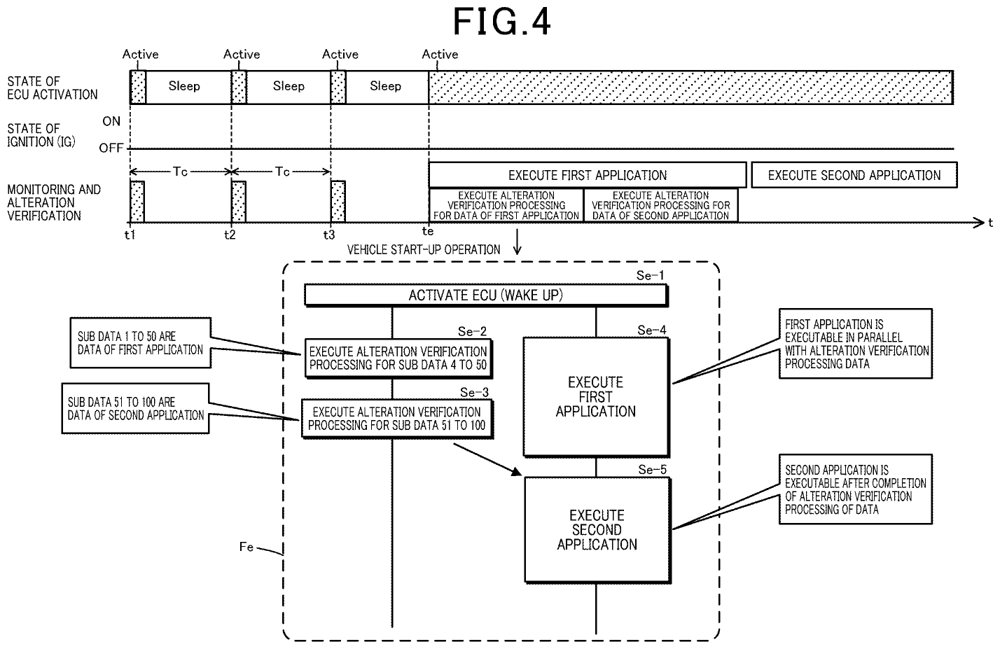

If the user operates the vehicle 1 to start up before the alteration verification processing for all of the sub data 1 to 100 is completed, the control unit 21 executes alteration verification processing for sub data for which alteration verification processing has not been completed as shown in FIG. 4. FIG. 4 illustrates a case in which a start-up operation of the vehicle 1 is performed at a time to in a state in which the sub data 1 to 3 have completed the alteration verification processing.

The control unit 21 executes a process Fe and activates the ECU 10 at step Se-1. Then, the control unit 21 concurrently executes the alteration verification processing for the sub data 4 to 50 in step Se-2 and the first application 32a in step Se-4. After completing the alteration verification processing for the sub data 4 to 50, the control unit 21 executes the alteration verification processing for the sub data 51 to 100 in step Se-3.

When completing the alteration verification processing for the sub data 51 to 100, the control unit 21 starts executing the second application 32b at step Se-5. In this way, the first application 32a is configured to be executable in parallel with the verification that no data has been altered, and thereby shortening the activation time at the start-up of the vehicle 1.

### 4. Other Embodiments

In the above embodiments, the exemplified moving bodies, which are electronic devices having the electronic device monitoring apparatus of the present disclosure, includes various vehicles such as four-wheeled vehicles, two-wheeled vehicles, vehicles driven by an internal combustion engines, electric vehicles, etc. but the moving bodies may be other types of moving bodies such as flying bodies and ships.

In the above embodiments, the exemplified electronic device of the present disclosure is the ECU 10 installed on the vehicle 1. However, electronic devices to be processed by the electronic device monitoring apparatus of the present disclosure may include any electronic device that periodically shifts from the sleep state to the active state and executes predetermined standby processing while the device is not in use and that has a storage unit that stores specific data to be subjected to alteration verification processing to verify whether there is any alteration.

In the above embodiment, the exemplified specific data of the present disclosure is the data of the moving body activation application 32, but the specific data of the present disclosure may be any data that requires verification that there is no alteration.

In the above embodiment, the data of the moving body activation application 32 is subdivided into sub data 1 to 100, but the sub data can be subdivided into any number.

In the above embodiment, the alteration verification processing is executed for one piece of sub data in parallel with the monitoring processing of the vehicle 1, but the alteration verification processing may be executed for two or more sub data in parallel with the monitoring processing of the vehicle 1.

In the above embodiment, the moving body activation application 32 includes the first application 32a and the second application 32b, the first application 32a is configured to be executable in parallel with the alteration verification processing of the data, and the second application 32b is configured to be executable after completion of the alteration verification processing of the data. In another embodiment, the moving body activation application 32 may be configured to be executable after completion of the alteration verification processing for all the sub data without setting such distinctions.

With the configuration that allows execution of the moving body activation application 32 after completion of the alteration verification processing for all sub data, if there is any sub data left for which alteration verification processing has not been completed at a start-up operation of the vehicle 1, the alteration verification processing is executed for the sub data left, and the moving body activation application 32 is subsequently executed. In this case, it is possible to re-execute the alteration verification processing for the sub data for which the alteration verification processing have already been completed to increase reliability against alteration.

In the above embodiment, the sub data verification processing is repeatedly executed every time when a certain period of time elapses through the processing of steps S208 and S209 in FIG. 2. However, the sub data verification processing may be repeatedly executed without waiting for the elapse of a certain period of time with steps S208 and S209 omitted.

FIG. 1 is a schematic diagram showing the configuration of an electronic device monitoring apparatus configured as a function of the ECU 10, with divisions according to main processing, to facilitate understanding of the present invention, but the device may be configured with other divisions. The processing of each component may be executed by one hardware unit, or may be executed by a plurality of hardware units. The processing of each component shown in FIGS. 2 to 4 may be executed by one program or may be executed by a plurality of programs.

### 5. Configurations Supported by Above Embodiments

The above embodiments are specific examples of the following configurations.

(Configuration 1) An electronic device monitoring apparatus including: a control unit that periodically shifts from a sleep state to an active state and executes predetermined standby processing while an electronic device is not in use; and a storage unit that stores specific data to be subjected to alteration verification processing for verifying whether there is any alteration, wherein the control unit executes sub data verification processing, the sub data verification processing performing the alteration verification processing for at least one piece of sub data out of a plurality of pieces of sub data at every shift to the active state in a preset order, the plurality of pieces of sub data being obtained by subdividing the specific data.

The electronic device monitoring apparatus of configuration 1 executes the alteration verification processing for the sub data in times when the control unit shifts from the sleep state to the active state. This makes it possible to reduce the frequency of shifting to the active state, to improve energy efficiency. The electronic device monitoring apparatus also executes the alteration verification processing in advance for the sub data while the electronic device is not in use. This makes it possible to skip the repeated alteration verification processing for the sub data that have already been verified to be unaltered by the alteration verification processing and to reduce the activation time of the electronic device at the start-up of the moving body.

(Configuration 2) The electronic device monitoring apparatus according to configuration 1, wherein the control unit stores information of no-alteration-confirmed in the storage unit, the information of no-alteration-confirmed indicating that the specific data has not been altered when the sub data verification processing verifies that none of all the sub data has been altered.

The electronic device monitoring apparatus of configuration 2 makes it possible to easily confirm that the specific data has not been altered, depending on whether the information of no-alteration-confirmed is stored in the storage unit.

(Configuration 3) The electronic device monitoring apparatus according to configuration 2, wherein, when a start-up condition of the electronic device is met in a state in which the information of no-alteration-confirmed is stored in the storage unit, the control unit does not re-execute the alteration verification processing for the specific data and executes activation processing of the electronic device.

The electronic device monitoring apparatus of configuration 3 skips the alteration verification processing for the specific data when the information of no-alteration-confirmed is stored. This makes it possible to shorten the time for completion of the activation processing at the start-up of electronic device.

(Configuration 4) The electronic device monitoring apparatus according to any one of configuration 1 to 3, wherein, when a predetermined time elapses from a time when the sub data verification processing completes the alteration verification processing for all the sub data, the control unit re-executes the sub data verification processing.

The electronic device monitoring apparatus of configuration 4 re-executes the sub data verification processing and thereby makes it possible to increase the reliability of verification that the specific data has not been altered.

(Configuration 5) The electronic device monitoring apparatus according to any one of configuration 1 to 4, wherein, when a start-up condition of the electronic device is met before the sub data verification processing completes the alteration verification processing for all the sub data, the control unit executes the alteration verification processing only for the sub data for which the alteration verification processing has not been completed and then executes activation processing of the electronic device.

The electronic device monitoring apparatus of configuration 5 skips the alteration verification processing for sub data for which the alteration verification processing has already been completed. This makes it possible to shorten the time for completion of the activation processing of the electronic device.

(Configuration 6) The electronic device monitoring apparatus according to configuration 5, wherein, when a start-up condition of the electronic device is met before the sub data verification processing completes the alteration verification processing for all the sub data, the control unit executes the alteration verification processing for the sub data for which the alteration verification processing has not been completed, and subsequently, at execution of the activation processing of the electronic device, the control unit re-executes the alteration verification processing also for the sub data for which the alteration verification processing has already been completed.

The electronic device monitoring apparatus of configuration 6 re-executes the alteration verification processing for the sub data for which the alteration verification processing has already been completed. This makes it possible to increase the reliability of verification that the specific data has not been altered.

(Configuration 7) The electronic device monitoring apparatus according to any one of configuration 1 to 4, wherein the specific data is data of an application to be executed at a start-up of the electronic device, the application includes a first application and a second application, the first application is configured to be executable in parallel with the alteration verification processing for data of the first application, and the second application is configured to be executable after completion of the alteration verification processing for data of the second application, and the control unit concurrently performs the alteration verification processing for data of the first application and execution of the first application when the sub data for which the alteration verification processing has not been completed is data of the first application, and the control unit executes the second application after completion of the alteration verification processing for data of the second application when the sub data for which the alteration verification processing has not been completed is data of the second application.

The electronic device monitoring apparatus of configuration 7 executes the alteration verification processing for the data of the first application for which the alteration verification processing has not been completed in parallel with the execution of the first application. This makes it possible to shorten the time for completion of the activation processing of the electronic device.

(Configuration 8) The electronic device monitoring apparatus according to any one of configuration 1 to 7, wherein the control unit executes predetermined fail-safe processing when the sub data verification processing recognizes that the sub data has been altered.

The electronic device monitoring apparatus of configuration 8 executes the fail-safe processing when recognizing that the sub data has been altered, and thereby makes it possible to support proper use of the moving body.

(Configuration 9) A moving body being an electronic device, the moving body including an electronic device monitoring apparatus according to any one of configuration 1 to 8.

Moving bodies such as vehicles execute processing, which is welcome performance, such as turning on the lights, unlocking the doors, and turning on the power when the users approach the moving bodies at the start-up of the moving bodies. Providing immediate responsiveness of the processing is important for improving convenience for users of the moving bodies. The moving body of the configuration 9 including an electronic device monitoring apparatus of the configurations 1 to 8 makes it possible to execute the alteration verification processing in advance for the specific data to be used in the moving body to enhance immediate responsiveness of the processing.

(Configuration 10) An electronic device monitoring method to be executed by a computer, the method including: a step of periodically shifting from a sleep state to an active state and executing predetermined standby processing while an electronic device is not in use; and a step of executing sub data verification processing, the sub data verification processing performing alteration verification processing for at least one piece of sub data out of a plurality of pieces of sub data at every shift to the active state in a preset order, the alteration verification processing verifying whether the sub data has been altered, the plurality of pieces of sub data being obtained by subdividing specific data, stored in a storage unit, to be subjected to the alteration verification processing.

The electronic device monitoring method of configuration 10 is executed by a computer, and thereby makes it possible to obtain the same effects and advantages as those of the electronic device monitoring apparatus of configuration 1.

### REFERENCE SIGNS LIST

1 . . . vehicle (moving body, electronic device), 10 . . . electronic device monitoring apparatus (ECU), 20 . . . processor, processor, 21 . . . control unit, 30 . . . memory (storage unit), 31 . . . control program, 32 . . . moving body activation application (specific data), 32a . . . first application, 32b . . . second application, 33 . . . information of no-alteration-confirmed, 40 . . . communication unit, 41 . . . camera, 42 . . . vibration sensor, 50 . . . portable terminal, 51 . . . portable key.

What is claimed is:

1. An electronic device monitoring apparatus comprising:
a control unit that periodically shifts from a sleep state to an active state and executes predetermined standby processing while an electronic device is not in use; and
a storage unit that stores specific data to be subjected to alteration verification processing for verifying whether there is any alteration,
wherein the control unit executes sub data verification processing, the sub data verification processing performing the alteration verification processing for at least one piece of sub data out of a plurality of pieces of sub data at every shift to the active state in a preset order, the plurality of pieces of sub data being obtained by subdividing the specific data.

2. The electronic device monitoring apparatus according to claim 1, wherein
the control unit stores information of no-alteration-confirmed in the storage unit, the information of no-alteration-confirmed indicating that the specific data has not been altered when the sub data verification processing verifies that none of all the sub data has been altered.

3. The electronic device monitoring apparatus according to claim 2, wherein
when a start-up condition of the electronic device is met in a state in which the information of no-alteration-confirmed is stored in the storage unit, the control unit does not re-execute the alteration verification processing for the specific data and executes activation processing of the electronic device.

4. The electronic device monitoring apparatus according to claim 1, wherein
when a predetermined time elapses from a time when the sub data verification processing completes the alteration verification processing for all the sub data, the control unit re-executes the sub data verification processing.

5. The electronic device monitoring apparatus according to claim 1, wherein
when a start-up condition of the electronic device is met before the sub data verification processing completes the alteration verification processing for all the sub data, the control unit executes the alteration verification processing only for the sub data for which the alteration verification processing has not been completed and then executes activation processing of the electronic device.

6. The electronic device monitoring apparatus according to claim 5, wherein
when a start-up condition of the electronic device is met before the sub data verification processing completes the alteration verification processing for all the sub data, the control unit executes the alteration verification processing for the sub data for which the alteration verification processing has not been completed, and subsequently, at execution of the activation processing of the electronic device, the control unit re-executes the alteration verification processing also for the sub data for which the alteration verification processing has already been completed.

7. The electronic device monitoring apparatus according to claim 1, wherein
the specific data is data of an application to be executed at a start-up of the electronic device, the application includes a first application and a second application, the first application is configured to be executable in parallel with the alteration verification processing for data of the first application, and the second application is configured to be executable after completion of the alteration verification processing for data of the second application, and
the control unit concurrently performs the alteration verification processing for data of the first application and execution of the first application when the sub data for which the alteration verification processing has not been completed is data of the first application, and the control unit executes the second application after completion of the alteration verification processing for data of the second application when the sub data for which the alteration verification processing has not been completed is data of the second application.

8. The electronic device monitoring apparatus according to claim 1, wherein
the control unit executes predetermined fail-safe processing when the sub data verification processing recognizes that the sub data has been altered.

9. A moving body being an electronic device, the moving body comprising an electronic device monitoring apparatus according to claim 1.

10. An electronic device monitoring method to be executed by a computer, the method comprising:
a step of periodically shifting from a sleep state to an active state and executing predetermined standby processing while an electronic device is not in use; and
a step of executing sub data verification processing, the sub data verification processing performing alteration verification processing for at least one piece of sub data out of a plurality of pieces of sub data at every shift to the active state in a preset order, the alteration verification processing verifying whether the sub data has been altered, the plurality of pieces of sub data being obtained by subdividing specific data, stored in a storage unit, to be subjected to the alteration verification processing.
